(19) United States
(12) Patent Application Publication
(10) Pub. No.: US 2020/0378623 A1
(43) Pub. Date: Dec. 3, 2020

(54) System for Heating a Room

(71) Applicant: Hall Labs LLC, Provo, UT (US)

(72) Inventors: David R. Hall, Provo, UT (US); Arjun Krishna, Orem, UT (US); Jeremy Johnson, Salem, UT (US)

(73) Assignee: Hall Labs LLC, Provo, UT (US)

(21) Appl. No.: 16/424,444

(22) Filed: May 28, 2019

(51) Int. Cl. F24D 13/02; H05B 3/26; H05B 1/02; H05B 3/14

(52) U.S. Cl. CPC F24D 13/024; H05B 3/26; H05B 2203/032; H05B 3/145; H05B 1/0277

(57) ABSTRACT

The invention includes a system for heating a room including a panel with a layer of channels, the layer of channels having a first and a second outer surface and a plurality of adjoined parallel channels disposed between them. The system also includes a heating element which converts electricity to heat and heats a fluid within the panel to heat the room.

### TECHNICAL FIELD

The present invention relates to radiant heating devices.

### BACKGROUND

Various solutions exist for heating spaces. Heating can be provided to a complete building, such as a residence, by a furnace that heats air, e.g. by combustion of a gas, which heated air is blown through vents into the building. Also, a boiler can heat water, oil, or other fluids, which circulate through pipes or radiators to heat rooms with radiant heat. Alternatively, electrical heaters can convert electricity to heat.

Typical radiant heating systems are often standalone units or are installed in floors. Sometimes, they are also installed in walls and ceilings. Some more recent radiant heating systems use PEX (cross-linked polyethylene) pipes or other types of pipes that are placed throughout the floor, wall, or ceiling, and water circulates through the pipes to heat the surrounding space. However, when the pipes in which the water circulates cover a small portion of the surface area where they are installed, such radiant heating systems may result in slow or uneven heating, especially when objects such as couches, bookshelves, pictures, or clocks are placed in front of or over the top of the system. Furthermore, such systems can be difficult to construct, install, or repair.

### SUMMARY

In a first aspect, the invention includes a system for heating a room including a panel with a layer of channels, the layer of channels having a first and a second outer surface and a plurality of adjoined parallel channels disposed between them. The system also includes a heating element which converts electricity to heat and heats a fluid within the panel to heat the room.

In a second aspect, the invention includes a radiant heat exchange system including a panel with an array of contiguous tubular vessels filled with fluid, a heater including an electrothermal resistor configured to receive electricity and to warm the fluid, and a pump configured to force the fluid through the panel.

In a third aspect, the invention includes a heating panel including a sheet of polycarbonate twinwall and at least one heating element which turns electricity to heat. The heating element heats a fluid mixture of water and glycol. The panel is divided into at least one zone that has a warmer side and a cooler side encouraging natural convection, the warmer side containing the heating element.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is perspective view of a system for heating a room according to one embodiment of the invention including two panels and a thermostat.

FIGS. 2a-2c are front views of various embodiments of the invention showing various heating chambers.

FIGS. 3a-3c are perspective views of embodiments of the invention using various layers of channels.

FIG. 4 is a perspective view of one embodiment of the invention including a vacuum layer.

FIG. 5 is a front view of one embodiment of the invention wherein the channels are grouped into zones with the use of plugs.

FIG. 6 is a perspective view of one embodiment of the invention including spacing elements.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, “contiguous,” as in “contiguous channels,” is generally meant to refer to the channels being separated by a common wall, although the key feature is that the channels are adjacent to each other.

As used herein, “heated,” as in “heated water,” is meant to refer to water that is generally above the ambient temperature of the room.

As used herein, “radiant area” is defined as the total cross-sectional area of the heated fluid in the plane parallel to the surface of the wall. For example, if an array of circular pipes containing heated fluid was in a wall, the radiant area would be total length of pipe in the wall, times its diameter. Radiant area does not include transport piping or area of fluid outside the room being heated.

As used herein, a “closed system” means a system of piping, channels, or other fluid containing tubular vessels which primarily reuses the same fluid rather than introducing new fluid during use of the system.

As used herein, “continuously-parallel circuit” is meant to refer to a circuit comprising two conductors disposed along the edge of a resistor such that an increased length of the resistor adds to the resistance in parallel, or in other words, reduces the overall resistance.

As used herein, the term “panel” is to be given a relatively broad meaning, referring to a component that has a depth smaller than the height and width. Preferably, the panels in this invention are flat and rectangular. Nevertheless, the panels may also be curved, bent and have shapes other than rectangles. Panel may refer to one portion of a prebuilt wall, or it may refer to one portion of a wall that is built in place.

As used herein, “thermal communication” refers to the exchange of energy between components, whether it be by conduction, convection, or radiation.

As used herein, “electrothermal” refers to the generation of heat from electricity.

Radiant heating, as opposed to convective heating, is popular due to its quiet nature and the fact that it does not spread allergens. It can also be more efficient than convective heating because it does not require heating up the air of the building before a user can feel the warmth.

Radiation is transferring electromagnetic energy in the form of infrared rays from one surface to the other surfaces around it. The amount of energy transferred depends on the both the temperature and area of the surface. A higher temperature and a larger surface area will increase heat transfer. Therefore, it is beneficial to increase the temperature and the surface area of a radiant heater. Or conversely, increasing the surface area can allow a radiant heater to operate at cooler temperatures, which may be useful when a source of heat is not hot enough to operate with a smaller surface area. It also can be safer.

In accordance with the present invention, the heat is generated by heating element which converts electricity to heat. The heating element thus heats the fluid in the channels and the panel can thus heat the room with radiant heat. Preferably, the fluid used in the channels is a conventional diathermic oil, namely, a heat transfer fluid typically used in heat transfer systems. It is ideal for use in the present invention, due to its high boiling point, low freezing point. In addition, it is electrically insulating.

In one embodiment of the present invention, the area of a radiant heater is maximized by containing the heated fluid in a panel made primarily of channels for fluid. One example is an extruded plastic panel of rectangle channels commonly called “twinwall” or “plastic cardboard.” The channels may be contiguous such that each channel shares a wall, or partition, with an adjacent channel. This way, most or all of the area of the panel is radiant area. This provides much more radiant area than a panel or wall with traditional pipes running through it. It also minimizes leaking and maintenance because fluid from a leaky channel may go into the adjacent channel. In some embodiments, the radiant area is preferably greater than 20% of the wall. Even more preferably, the radiant area is greater than 50% of the wall. Even more preferably, the radiant area is more than 90% of the wall. The greater the radiant area is, the smaller the heat differential between the heating fluid and the room needs to be.

The fluid used in the system to transfer energy into or out of the room could be any fluid that is not harmful to the system, including gases or liquids. As noted above, a diathermic oil is preferred. Alternatively, liquids, such as water, have many ideal characteristics, such as high emissivity, high specific heat, and low cost. However, water tends to allow growth of organisms and has the potential of freezing. Glycols, such as ethylene glycol or propylene glycol, are commonly added to water to lower the freezing point and prevent growth of organisms. However, glycol reduces the specific heat of the mixture, so more volume is required through the system than with water alone. There are many glycols which share similar physical properties and are suitable for use in the invention, but the preferred embodiment typically uses propylene glycol because it is non-toxic and safer if there is a leak or spill. Preferably, the fluid is a water mixture with 20% to 45% glycol. Even more preferably, the fluid is a water mixture with 25% to 40% glycol. Even more preferably, the fluid is a water mixture with 30% to 32% glycol. In other embodiments, the fluid contains oil, such as diathermic oil, which has the additional benefit of remaining a liquid at higher temperatures than water.

One benefit of the present invention is that fluid may circulate through the panel in a plurality of ways. In one embodiment, the fluid may rise up one channel and down the next, repeating through the channels from one side of the panel to the other. In another embodiment, the channels may be grouped into zones wherein the fluid passes up two or more channels, and then down two or more channels, repeating through the channels from one side of the panel to the other in a serpentine fashion. Additionally, the fluid may travel the same way through all the channels, such as from top to bottom. In yet another embodiment of the invention, the fluid passes from one side to the other side through any configuration of channels, but then returns to the first side typically through a top or bottom channel. In that embodiment the fluid may never leave the panel, but will cycle through it.

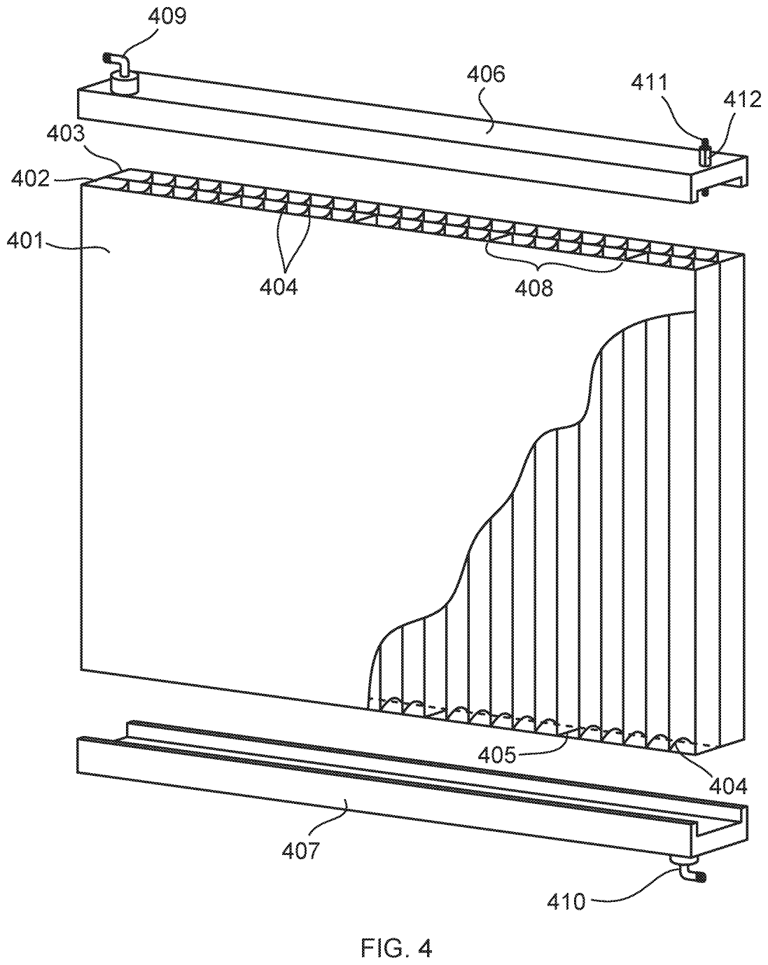

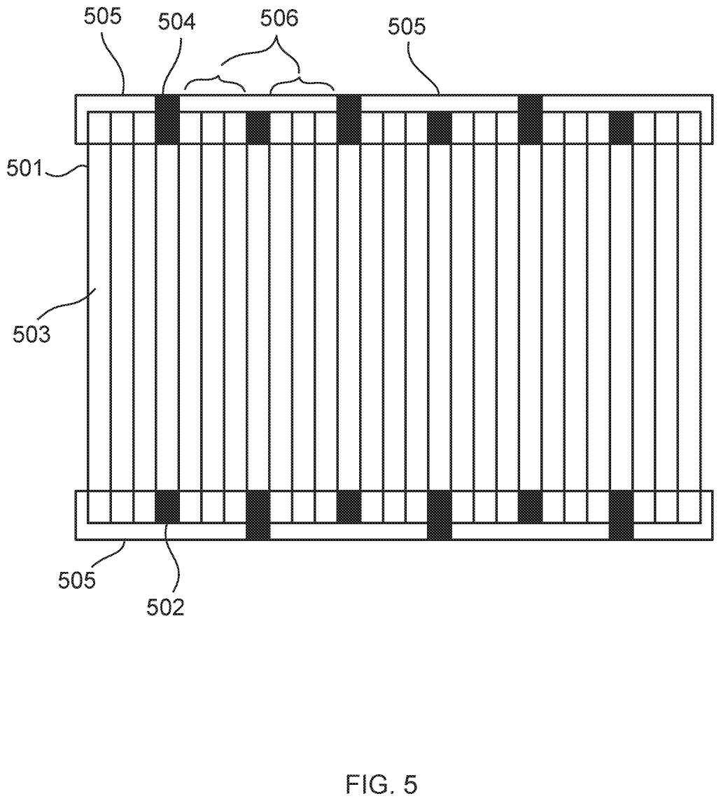

The panel may be divided into zones in many ways. In one embodiment of the invention, one or more channels may have a notch or carveout of a section of a partition dividing it from another channel which puts two channels in fluid communication with each other. Many channels can be formed into a zone with neighboring carved-out partitions between channels. See FIG. 4 for an example of carved-out partitions. Another way is with an endcap placed over an open end of a panel that puts some channels in communication with each other while blocking off others. In that configuration, there may be an opposing and corresponding endcap configured to provide the same zones as depicted in FIG. 5.

To prevent fluid from leaving the panel, some embodiments of the invention include an endcap. The endcap covers an open end of the channel. In some embodiments, the endcap is configured to redirect fluid from one channel or zone into another channel or zone. In one embodiment, the endcap is a manifold which distributes the fluid into more than one channels or zones.

The invention may also comprise a closed type system. In one embodiment, the fluid is in a closed system, wherein fluid is not added to the system except to replace fluid lost during maintenance or leaks.

The invention also provides flexible installation options, including covering options. In one embodiment, the panel includes a finishable surface, such the fibrous surface of drywall. In other embodiments, the panel includes a decorative surface, such as a wallpaper or a painted surface. All of such options will help to make the panel's appearance unnoticeable. In other embodiments, it has a no covering or only a thin decorative covering to reduce the amount of heat absorbed by the wall. A thin decorative covering may be traditional paint, wallpaper, or canvas, which itself may have a painted or printed image. The decorative covering preferably also has a has a low thermal conductivity but a high emissivity, such as a velvet wallpaper, in order to make the wall cooler to the touch while still warming the room through radiation.

In other embodiments, the panel has a layer of insulation, typically on the back side, either to reduce heat transfer through the wall or to reduce noise, or both. Insulation could be traditional fiberglass or foamboard, or it could comprise a second channel layer configured to insulate. In one embodiment, one or more additional channel layers, preferably made of twinwall, may be used and is filled with sound damping material such as soil or barite. In other embodiments, additional channel layers may be used with a layer of air to discourage sound vibrations and heat transfer.

One embodiment of the invention utilizes multiple channel layers configured to aid insulation, noise reduction, or reduce condensation by pulling a vacuum in one of the layers. This is possible by using multiple sheets of extruded material which are placed adjacent to each other or a single panel of extruded material which has multiple channel layers within it. Channels of air make great insulators, but channels with a vacuum are better because there is no convection or conduction through an empty space. One embodiment of the invention has a single panel with three channel layers, as depicted in FIG. 5c. Heated fluid may run through the layer closest to the room to deliver heat to the room, and the middle or rear layer would have a vacuum. The third layer may also have a vacuum, however it could be filled with air or an insulator, such as barite, or it could be a second fluid containing layer. In the preferred embodiment of this configuration, the vacuum layer is on the front and the fluid-containing layer is in the middle or back. This could drive radiation as the main heat transfer mechanism.

The invention can be versatilely installed into the structure of a home. It can simply replace drywall and be supported by a support structure, such as wooden studs, or it can comprise a structural layer, such as a layer of sheet metal, and support the building. In one embodiment of the invention, a single panel is installed in a room. In other embodiments, more than one panel can be connected with fluid communication between the panels, which will increase the radiant area. In yet other embodiments, the panels make up the majority or the entire wall structure of the home. In yet other embodiments, the panels are configured to be retrofit into established buildings.

In addition to being installed into the structure of the home, the panels may be prefabricated-standalone panels. In one embodiment, the panel is fixed to the outside of a preexisting wall, but in others it supports itself either by leaning against a wall or with its own support structure, or hung like a decorative item. The prefabricated wall may be entirely mobile.

In an embodiment of the invention, the water is heated within the wall. The fluid may stay in the panel rather than be pumped to a remote heater. A resistive heater may be located either within a channel or near the panel such that it can heat the fluid either conductively, convectively, or radiatively, or by a combination thereof. In a preferred embodiment of the invention, a resistive heater is disposed within a channel layer, such as an elongated resistive heating element.

Another embodiment of the invention uses a reflective layer disposed within the panel to help direct heat transfer in a particular direction. Materials with very low emissivity (ability to radiate energy), such as aluminum, brass, chromium, or silver, among others, may be placed on the back side of the panel in order to reduce radiation into the wall. In the preferred embodiment, a reflective layer will have an emissivity lower than 0.1 and be economically sourced, such as aluminum foil with an emissivity of 0.04.

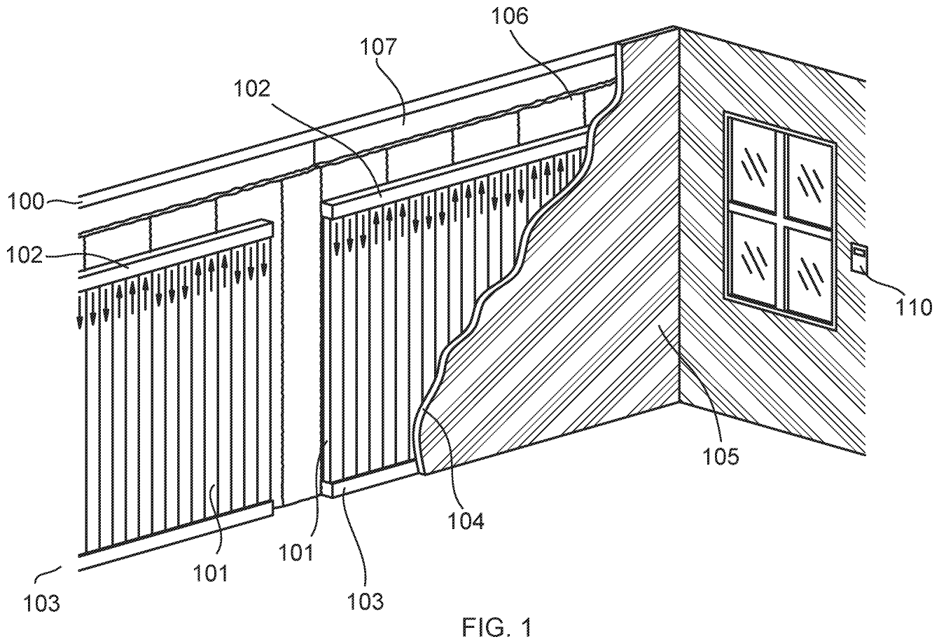

Now referring to FIG. 1, one embodiment of a radiant heating system is shown 100. A channel layer 101 comprises a panel of contiguous channels, which are filled with a fluid which can be heated by the heating element. The channels may be configured into zones such that fluid travels the same direction through each zone rather than alternating each adjacent channel. In the depicted embodiment, fluid is supplied to three channels through an upper manifold 102, and then redirected into the next three channels through a lower manifold 103. The upper manifold 102 and lower manifold 103 also serve to redirect the fluid through the rest of panel, where it finally exits the panel through the lower manifold 103.

In the depicted embodiment, the channel layer 101 is covered with a sheet of drywall 104, which is covered with a layer of wallpaper, 105. Insulation 106 is placed behind the channel layer 101 in order to prevent heat loss into the wall. A layer of low-emissive material, such as foil 107, is placed behind the insulation 106 to prevent radiation through the back side of the wall.

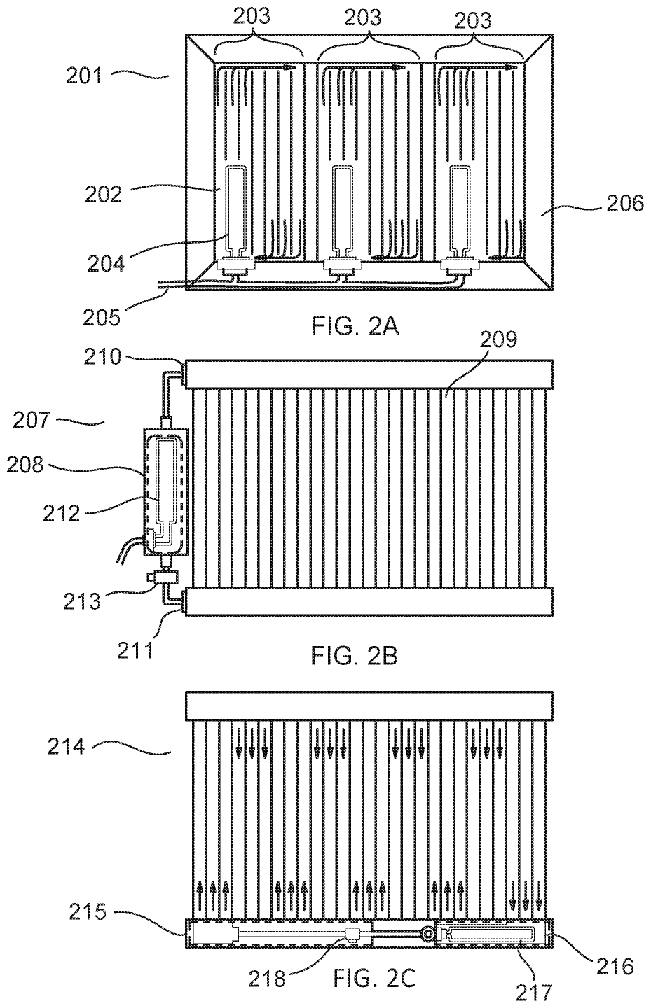

Now referring to FIG. 2, which shows various embodiments of the invention with a heating element in a heating chamber. In FIG. 2A, a heater 201 contains a heating chambers 202 made by removing portions of the partitions between channels. Heating elements 204 are disposed in heating chambers 202. In this embodiment, the panel is divided into zones 203, wherein the fluid moves by natural convection up one side of the zone and down the other. Natural convection is encouraged by the fact that the heating elements 204 are in half of the zone, which creates a warmer side and a cooler side. In the warmer side, the fluid is less dense and tends to rise. Once the fluid has lost some energy to the room and cooled down, it becomes more dense and flows down the cooler side of the zone. The heating elements 204 include a power cord 205 adapted to receive and supply electricity to the heating elements 204. A frame 206 encases the system into a single portable unit and also gives the system a better finished/aesthetic look.

FIG. 2B shows another embodiment of a heating panel with a heating element external to the panel. A heater 207 has a heating chamber 208 which is external to a radiant panel 209. The radiant panel 209 includes an inlet 210 and an outlet 211 which connect the heating chamber 208 to the radiant panel. Within the heating chamber is a heating element 212. In the preferred embodiment, a pump 213 moves a fluid from the radiant panel, through the heating chamber, and back into the radiant panel.

FIG. 2C shows another embodiment of the heating panel with a heating element in an endcap. An endcap 215 contains a heating chamber 216 housing a heating element 217. The endcap 215 further includes a space for a pump 218.

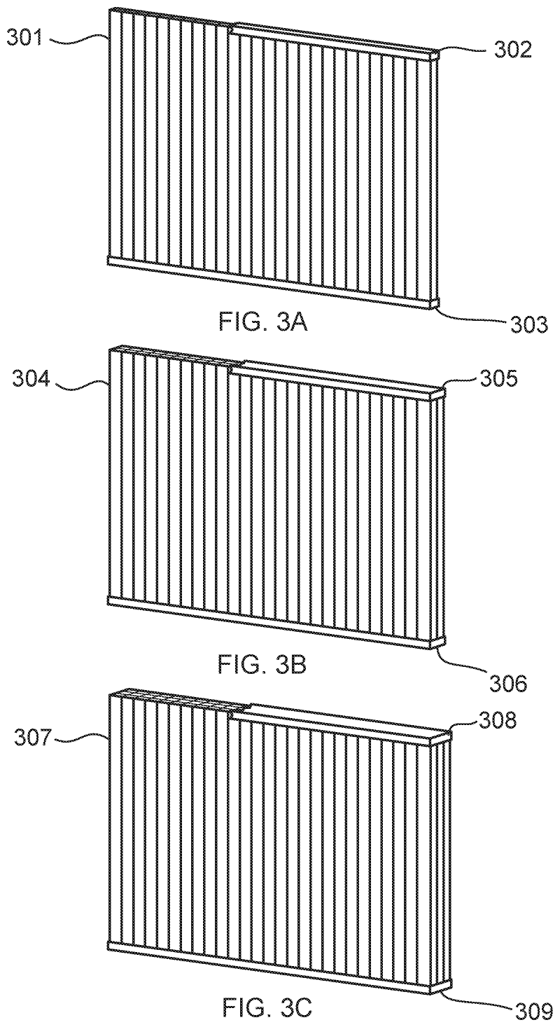

Now referring to FIG. 3, which shows multiple embodiments of the invention. FIG. 3A shows a radiant panel with a single row of channels 301. Endcaps 302 and 303 keep fluid from escaping the panel. FIG. 3B shows a radiant panel with two rows of channels 304. Endcaps 305 and 306 keep fluid from escaping the panel. FIG. 3C shows a radiant panel with three rows of channels 307. Endcaps 308 and 309 keep fluid from escaping the panel.

Now referring to FIG. 4, which shows an embodiment of the invention with a vacuum layer and a fluid layer. A radiant panel 401 has two rows of channels, a fluid layer 402 and a vacuum layer 403. Some of the partitions of the fluid row have a notch 404 allowing fluid to flow between them, while others extend to the end of the channel 405 to form a barrier between the partition and the endcaps 406 and 407. This allows a fluid to flow in the same direction through multiple channels, or zones 408. In this embodiment, the vacuum layer does not have any zones. A fluid inlet 409 and outlet 410 are on the endcaps and allow fluid to enter and exit the fluid layer. A vacuum nozzle 411 with check valve 412 is mounted on endcap 406 on the side of the vacuum layer, which allows air to be removed from the vacuum layer without reentering.

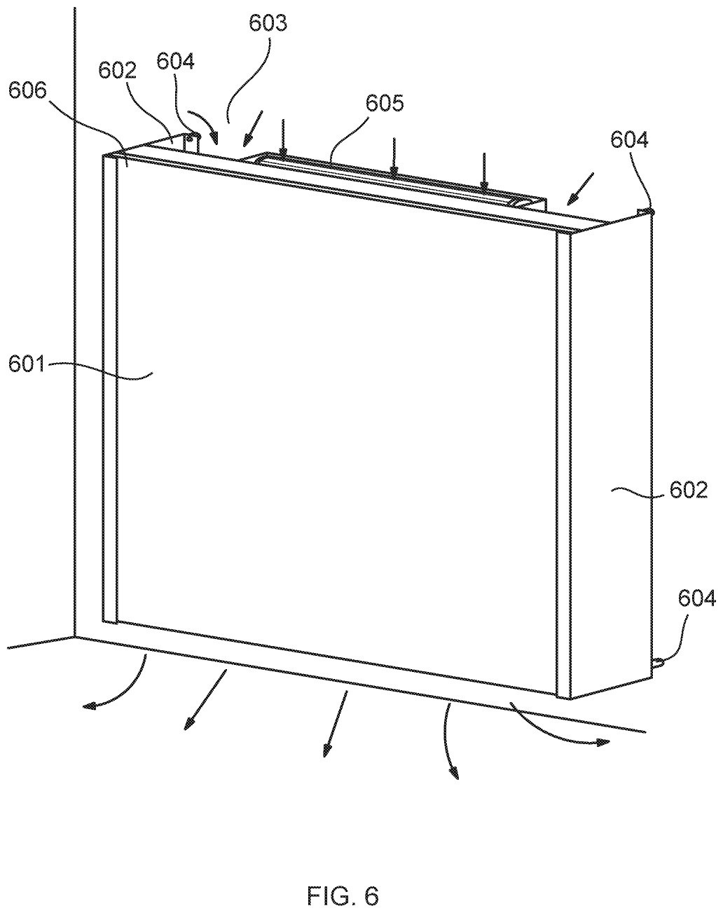

Now referring to FIG. 5, which shows one embodiment of the invention using plugs to create zones. A radiant panel 501 is shown in a serpentine configuration. Smaller plugs 502 prevent fluid from entering a channel 503, while larger plugs 504 prevent fluid from entering a channel and also passing through the endcaps 505. Zones 506 are created, in this case, each with three channels. The small and large plugs are offset such that fluid flows from side to side in a serpentine configuration through the panel. In this configuration, the endcaps 505 create manifold areas 506 that redirect the fluid back into the channels in contrast to FIG. 6 which uses notches within the channels to do this.

Now referring to FIG. 6, a heating system is depicted with a gap between a panel and a wall to allow airflow. A radiant panel 601 is attached to a wall with two mounting brackets 602. The mounting brackets 602 are also spacers which create an air-channel 603 between the wall and the panel 601. The system further includes sound damping spacers 604 to reduce sound propagation to or from the wall. A fan 605 may help air flow and energy transfer to the room. In the preferred embodiment, the fan is a low rpm squirrel-cage fan, however, other fans such as propeller fans may also be used.

All patents and published patent applications referred to herein are incorporated herein by reference. The invention has been described with reference to various specific and preferred embodiments and techniques. Nevertheless, it is understood that many variations and modifications may be made while remaining within the spirit and scope of the invention.

What is claimed is:

1. A system for heating a room comprising:
a panel comprising a layer of channels, the layer of channels having a first and a second outer surface and a plurality of adjoined parallel channels disposed therebetween,
the layer of channels containing a fluid for heating;
a heating element disposed within the panel and configured to convert electricity into heat, thereby heating the fluid and heating the room.

2. The invention of claim 1 wherein the heating element is disposed within a heating chamber, wherein the heating chamber is formed within at least a portion of one or more channels of the panel.

3. The invention of claim 1 further comprising a pump configured to move fluid through the panel.

4. The invention of claim 1 further comprising a thermostat configured to turn the system on and off to maintain a desired temperature range.

5. The invention of claim 1 further comprising an endcap.

6. The invention of claim 5 wherein the endcap comprises the heating chamber.

7. The invention of claim 5 wherein the endcap is a manifold configured to combine the channels into zones.

8. The invention of claim 1 wherein the panel comprises extruded polycarbonate.

9. The invention of claim 1 wherein the fluid is diathermic oil.

10. The invention of claim 1 wherein the fluid comprises water and glycol.

11. The invention of claim 1 further comprising spacers configured to offset the panel from a wall.

12. The invention of claim 11 further comprising a fan.

13. A radiant heat exchange system comprising:
a panel comprising an array of contiguous tubular vessels containing a fluid;
a heating element comprising an electrothermal resistor configured to receive electricity and to warm a fluid; and
a pump configured to circulate the fluid through the panel.

14. The invention of claim 13 wherein the fluid comprises water and at least 20% glycol.

15. The invention of claim 13 further comprising a layer of insulation and a reflective layer.

16. The invention of claim 15 further comprising a frame configured to encase the system into a single mobile unit.

17. The invention of claim 13 wherein the fluid is diathermic oil.

18. The invention of claim 13 wherein the panel is divided into two or more zones, and wherein there is a heating element in each zone.

19. A heating panel comprising:
a sheet of polycarbonate twinwall;
at least one heating element comprising an electrothermal resistor configured to receive electricity disposed in the panel;
a cord with a plug configured to connect the heating element to a household electrical outlet;
a fluid mixture of water and glycol;
wherein the panel is divided into at least one zone, the zone containing a warmer side and a cooler side encouraging natural convection;
wherein the at least one heating element is disposed in the warmer side of the at least one zone.

20. The invention of claim 19 further comprising a temperature sensor and a switch, wherein the switch is configured to turn the heater on when the temperature sensor senses a predetermined temperature and turn off the heater when the temperature sensor senses a second predetermined temperature.
